(19) United States
(12) Patent Application Publication
(10) Pub. No.: US 2017/0125942 A1
(43) Pub. Date: May 4, 2017

(54) CONNECTOR HAVING LOCKING OF THE LEVER FOR FACILITATING THE CONNECTION

(71) Applicant: DELPHI INTERNATIONAL OPERATIONS LUXEMBOURG S.A.R.L., BASCHARAGE (LU)

(72) Inventors: Melanie Guillanton, Epernon (FR); Sylvain Loas, Louveciennes (FR)

(21) Appl. No.: 15/296,306

(22) Filed: Oct. 18, 2016

(30) Foreign Application Priority Data
Oct. 28, 2015 (FR) 1560283

(51) Int. Cl. H01R 13/629; H01R 13/627

(52) U.S. Cl. CPC H01R 13/62955; H01R 13/62938; H01R 13/6273

(57) ABSTRACT

The invention relates to a connector having a lever for facilitating the connection. The connector comprises a housing on which a lever is rotatably mounted between an open position, in which a counter-connector may be coupled to the connector in one direction of coupling, and a closed position, in which the connector and the counter-connector are locked together. The lever is maintained in the closed position by a lock that is connected to the housing with the help of two tabs, each extending respectively from the lock towards the housing, in a direction perpendicular to the direction of coupling. In order to disengage the lever and the lock, the lock is displaced towards the housing by a translation perpendicular to the direction of coupling.

### CROSS-REFERENCE TO RELATED APPLICATION

This application claims the benefit under 35 U.S.C. §119(a) of Patent Application No. 1560283 filed in the Institut National de la Propriété Industrielle (French Patent Office) on Oct. 28, 2015, the entire disclosure of which is hereby incorporated by reference.

### TECHNICAL FIELD OF THE INVENTION

The invention relates to the field of connector technology, and in particular that of automotive connector technology.

### BACKGROUND OF THE INVENTION

Connectors are used to transmit signals or electrical energy between cables, devices (computer, lighting, etc.) or motors. In particular, electrical connectors include electrical contacts in a greater or smaller number, or of a larger or smaller size. The contact force must be sufficiently high in order to ensure good electrical conduction between male and female contacts. For this reason, and in particular if contacts are of a relatively large size, for example as a result of being connected to a source of an electrical power supply, the insertion force of the male contact into the female contact may become relatively high.

In order to avoid the risks of musculoskeletal disorders for the operators responsible for the fitting and the connection of the connectors, certain connectors are equipped with a device for facilitating the coupling. Such a device for facilitating the coupling may include a sliding drawer or a rotating lever, for example.

Electrical connectors including a housing and a lever for facilitating the connection are thus already familiar. This type of lever includes at least one lever arm articulated on the housing about an axis of rotation between at least one opened position and one closed position. In general, the lever includes two lever arms, each respectively articulated on a lateral face of the housing and connected to one another via a handle. In the opened position of the lever, the connector may be coupled with a counter-connector. The lever is then subsequently pivoted, for example through an angle of 90°, in the closed position in which it maintains the connector and the counter-connector coupled one with the other. In the course of the passage from the open position to the closed position, a device constituted by elements engaging one in the other in a complementary manner (for example a cam and a pad), each situated respectively on the lever and on the counter-connector, assures the movement together one towards the other, and the coupling one with the other, of the connector and of the counter-connector.

On completion of the coupling, there is generally a desire to lock the connector and the counter-connector together and to prevent them from being uncoupled unintentionally under the effect of vibrations, or for some other reason. Previously disclosed for this purpose, for example, are connectors of which the housing is provided with a lock in order to maintain the lever in a closed position.

International Patent Publication No. WO 2010/136832 A2 describes a connector including a housing and a lever for facilitating the connection. The lever for facilitating the connection has at least one lever arm articulated on the housing, about an axis of rotation, between at least one open position, in which a counter-connector may be coupled to the connector in a direction of coupling perpendicular to the axis of rotation of the lever, and a closed position, in which the connector and the counter-connector are locked together. In addition, a lock is molded together with the housing, which lock cooperates with the lever in order to maintain it in the closed position. The lock is essentially constituted by a protuberance surmounting a bridge rising above the upper face of the connector. The bridge is connected to the housing, on the one hand, by a first connection portion situated towards the rear of the connector and, on the other hand, by second connection portions situated towards the front of the housing, that is to say in proximity to the coupling face with a counter-connector. The first and second connection portions are sufficiently flexible and elastic for the bridge and the protuberance to latch into engagement with a complementary part of the lever in order to lock the lever or, conversely, in order for them to be capable of releasing the latter.

In certain cases, the maximum authorized dimensions for the connector are such that this type of configuration described in WO 2010/136832 is not acceptable.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY OF THE INVENTION

One aim of the invention is to provide a connector with a lever for facilitating the connection that is more compact than the connectors of the prior art.

This aim is achieved at least in part with a connector in which the lock is connected to the housing with the help of two tabs, each extending respectively from the lock as far as the housing in a direction perpendicular to the direction of coupling, and which maintain the lock in an at-rest position in which a distance is provided between the lock and the housing.

In fact, with this type of arrangement in which the lock and the elastic tabs are arranged transversally in relation to the direction of coupling, the lock is displaced, in order to be locked or unlocked, essentially according to a translation perpendicular to the face of the housing on which the lock is articulated. A lock articulated about an axis perpendicular to the direction of coupling, making it possible to obtain the same stroke by rotation and possessing the same robustness, would exhibit a larger dimension in the direction of coupling. Thus, thanks to the invention, it is possible to obtain a connector that is shorter and therefore more compact in the direction of coupling. The connector may possibly be shorter in the direction of coupling, in inverse proportion to its width in a direction parallel to the axis of rotation of the lever (it should be noted that, when the lever is articulated on the housing with the help of a system of cams, the axis of rotation may possibly be mobile in the course of the rotation, although it remains parallel at all times to the same direction).

The connector may in addition include one or other of the following characterizing features considered in isolation or in combination one with the other:
the housing forms an abutment limiting the deformation of the tabs when the lock is pressed in the actuating direction; it is thus possible to reduce the risk of rupture of the tabs;
the tabs are disposed symmetrically to either side of the lock; it is thus possible to assure greater stability and greater robustness of the lock when the latter receives a pressure; this likewise makes it possible to impose on the lock a displacement towards the housing having a component that is principally in translation (with few, or even no component in rotation in an axis perpendicular to the direction of coupling);
the lock includes two chamfers, being an external chamfer on which the lever slides when it is displaced towards its closed position, and an internal chamfer on which the lever slides when it is displaced towards its open position in order to be unlocked; the chamfers assist with the passage of a pressure point in order to achieve closing or opening of the lever; the ergonomic element provides the operators with a supplementary indication in respect of the fact that the locking/unlocking of the coupling of the connector and of the counter-connector has been properly implemented;
the lever includes two chamfers, each cooperating respectively with the internal chamfers and the external chamfers of the lock when the lever is displaced from its closed position towards its open position and conversely; the characterizing feature confers to the connector advantages that are similar to those described in the preceding paragraph;
the lever includes two lever arms, being on the one hand articulated on the housing about the axis of rotation of the lever and on the other hand connected to one another via a handle, and the lock is present, when the lever is in the closed position, in a space situated to the side of the lever arms in relation to the handle; in other words, the lock may be positioned between the arms of the lever and may thus be contained within the dimensions of the lever itself, without adding additional dimensions;
the lock and the handle each exhibit respectively an actuating surface extending essentially into the same plane when the lever is in the closed position; the compactness of the connector is thus optimized, since the lock does not exceed the dimensions of the lever itself; even more advantageously, the respective actuating surfaces of the lock and the handle may extend essentially in the same plane as a face of the housing; in this way, the lever and the lock do not extend essentially beyond the face of the housing for the supplementary optimization of the compactness; and
the lever pivots from its open position towards its closed position as it moves away from a face of the housing, via which face the connector is coupled to the counter-connector; this arrangement may make it possible to position the handle essentially in the extension of the housing, and to limit the dimensions of the connector in respect of its height (perpendicularly to the upper face, that is to say parallel to the coupling face and perpendicularly to the axis of rotation), since neither the lever, nor the lock extend (at least significantly) beyond the upper face of the housing.

According to another aspect, the invention relates to a connection assembly including a connector as described above and a counter-connector, into which the connector and the counter-connector are displaced one towards the other in the course of the rotation of the lever from its opened position towards its closed position.

### BRIEF DESCRIPTION OF THE SEVERAL VIEWS OF THE DRAWING

The present invention will now be described, by way of example with reference to the accompanying drawings, in which:

FIG. 1 depicts schematically in perspective a connection assembly including a connector and a counter-connector, the latter already being coupled in part, but the lever not being in a closed and locked position;

FIG. 2 depicts schematically in perspective a partial view in longitudinal section of the connection assembly in FIG. 1, in the same position as depicted in FIG. 1;

FIG. 3 depicts schematically in perspective the connection assembly depicted in FIGS. 1 and 2, with the connector and the counter-connector in a coupled position, and with the lever in a closed and locked position; and

FIG. 4 depicts schematically in perspective a partial view in longitudinal section of the connection assembly depicted in the preceding figures, in the same position as in FIG. 3.

In the various figures, similar or identical elements bear the same references.

### DETAILED DESCRIPTION OF THE INVENTION

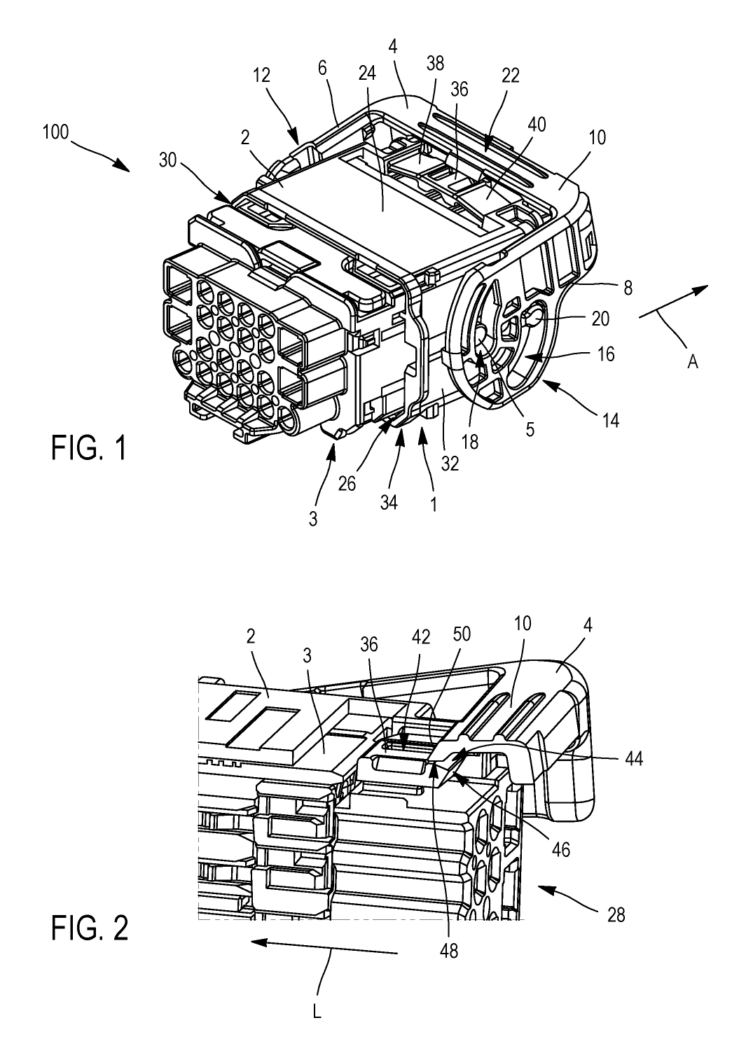

A non-limiting example of a connection assembly 100 depicted in FIG. 1 includes a connector 1 and a counter-connector 3. These are connectors that are used for automotive connector technology applications.

These are straight connectors, that is to say not elbowed, in which the cables (not depicted here) exit via opposite faces, being essentially parallel with each other and perpendicular to the direction of coupling A.

The connector 1 includes a housing 2 and a lever 4. It likewise includes female contacts or clips constituted by a metallic conductor, albeit not depicted here. Similarly, the counter-connector 3 includes male contacts or tongues (likewise not depicted in the figures) constituted by a metallic conductor.

The lever 4 includes two lever arms 6, 8 and a handle 10 connecting the two lever arms 6, 8 in order to form a “U”. Each lever arm 6 or 8 is integrally formed with a flange 12 or 14 situated at the other extremity of the lever arm 6 or 8 in relation to the handle 10. Each flange 12 or 14 is articulated on the housing 2 about an axis of rotation perpendicular to the flanges 12, 14. For this purpose, each flange 12 or 14 includes two guide grooves 16, 18 in the arc of a circle. One groove 16 of the grooves 16, 18 receives a pin 20 of the connector 1, while the other groove 18 of the grooves 16, 18 receives a pin 5 of the counter-connector 3. The two guide grooves 16, 18 of the same flange 12 or 14 are not concentric (the center of each of the arcs of a circle is situated beyond the groove 16 or 18 which faces it). It is thus possible to optimize the dimension of the flanges 12, 14 for a maximum travel and a minimum dimension of the connector 1.

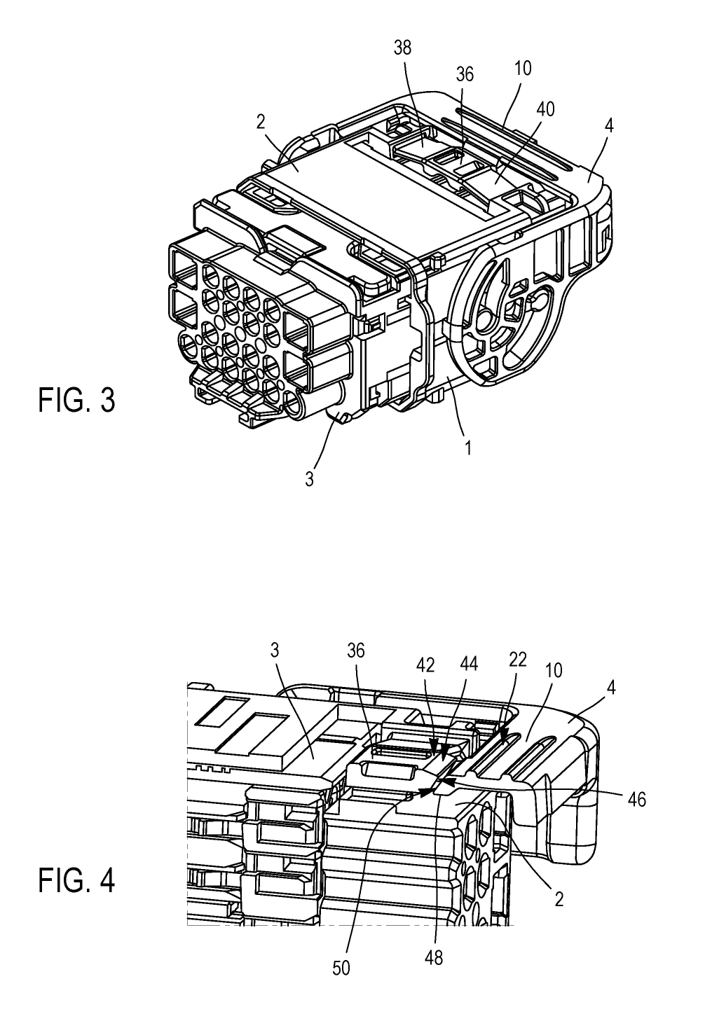

The handle 10 includes an actuating surface 22 on which an operator may pull or push in order to displace the lever 4 from its opened position towards its closed position. The actuating surface 22 is present essentially at the level of, or in the extension of the upper face 24 of the housing 2 when the lever is in the closed position (see also FIGS. 3 and 4).

The housing 2 includes:
a coupling face 26 via which a part of the counter-connector 3 is introduced,
a rear face 28 (see FIG. 2), opposite the coupling face 26 in relation to the longitudinal direction L (parallel to the direction of coupling A), and via which cables exit,
two lateral faces 30, 32, on which the lever 4 is rotatably mounted,
a lower face 34, and
an upper face 24, above which the lever 4 pivots between an open position, into which the lever arms 6, 8 extend essentially perpendicularly to the upper face 24, and a closed position, into which the lever arms 6, 8 extend essentially parallel to the upper face 24.

The lever 4 pivots from its open position towards its closed position as it moves away from the coupling face 26 of the connector 1 with the counter-connector 3. More specifically, the handle 10 of the lever 4, when the latter is in the closed position, is present at the level of the rear face 28 of the housing 2.

A bridge is formed above the upper face 24. The bridge is molded together with the housing 2. The bridge includes a lock 36 in the middle of two elastic tabs 38, 40. Each elastic tab 38 or 40 is connected on the one hand to the lock 36 and on the other hand to the upper face 24 by an articulation, hinge or some other flexible zone. The two elastic tabs 38, 40 extend to either side of the lock 36 in a direction essentially perpendicular to the direction of coupling A. More specifically, the tabs 38, 40 extend from the upper face 24 towards the lock 36 as they move away from the upper face 24, that is to say by forming an acute angle at the level of the articulation of the tabs 38, 40 with the upper face 24. The lock 36 is thus raised in relation to the upper face 24 (for example, the distance between the lock 36 and the upper face 24 is in the order of 2 mm).

The lock 36 includes an actuating surface 42 that an operator may press in order to displace the lock 36 towards the housing 2. When the lever 4 is in the closed position, the respective actuating surfaces 22, 42 of the lock 36 and of the handle 10 extend essentially in the same plane, which likewise corresponds to the highest plane of the upper face 24 of the housing 2 (see FIG. 4). Since nothing extends beyond the upper face 24 of the housing 2, it is possible to reduce the dimensions of the connector 1 and to gain compactness.

The lock 36 is present, when the lever 4 is in the closed position, in a space situated to the side of the lever arms 6, 8, in relation to the handle 10, that is to say between the branches of the “U” formed by the lever 4 (see FIG. 1).

The lock 36 includes two chamfers 44, 46, being an external chamfer 44, on which an internal chamfer 48 of the lever 4 slides when the lever 4 is displaced towards its closed position, and an internal chamfer 46, on which an external chamfer 50 of the lever 4 slides when the lever 4 is displaced towards its open position in order to be unlocked. The internal chamfers 48 and external chamfers 50 of the lever 4 are positioned on the handle 10 of the lever 4 (see FIG. 2).

In the course of the pivoting of the lever 4 from its opened position to its closed position, the respective external chamfers 44 of the lock 36 and internal chamfers 48 of the handle 10 interact with one another. The lock 36 and its tabs 38, 40, on the one hand, and the lever 4 with its handle 10, on the other hand, are sufficiently flexible to permit the displacement of the chamfers 44, 48 in relation to one another. The inclination of the surface of the chamfers 44, 48 is such that the pressure exerted on the lever 4 in order to close it induces a displacement of the lock 36 principally in translation perpendicularly to the upper face (that is to say to a plane parallel to the direction of coupling A and to the axis of rotation of the lever 4). A pressure point is reached when the contact surface of the chamfers 44, 48 is minimal. The lever 4 then exits from the lock 36, which is able to return elastically into an at-rest position with its internal chamfer 46 facing towards, and above, the external chamfer 50 of the lever 4. The lock 36 maintains the lever 4 in the closed position in this way.

In order to unlock the lever 4, an operator exerts a pressure, for example with the thumb of one hand, in an actuating direction (essentially perpendicular to the actuating surface 42), on the actuating surface 42 of the lock 36, and then pulls the handle 10 of the lever 4 with the index finger of the same hand, in order to cause the lever 4 to pivot, which itself, via the intermediary of the guide grooves 16, 18 on its flanges 12, 14, displaces the counter-connector 3 in order to extract it from the connector 1. An operator may uncouple the connector 1 and the counter-connector 3 in this highly ergonomic manner.

In the course of this operation, the application of pressure on the lock 36 by the operator brings it into abutment on the upper face 24 of the housing. The internal chamfer 46 of the lock interacts with the external chamfer 50 of the handle 10 of the lever 4, until the surfaces facing the chamfers 46, 50 is minimal. A relatively light pull on the handle 10 of the lever 4 is then sufficient to pass a pressure point and to cause the lever 4 to pivot from its closed position towards its open position.

While this invention has been described in terms of the preferred embodiments thereof, it is not intended to be so limited, but rather only to the extent set forth in the claims that follow. Moreover, the use of the terms first, second, primary secondary, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

We claim:

1. A connector, comprising:
a housing;
a lever having at least one lever arm articulated about an axis of rotation on the housing configured to move between at least one open position, in which a counter-connector may be coupled to the connector in a direction of coupling perpendicular to the axis of rotation of the lever, and a closed position, in which the connector and the counter-connector are locked together; and
a lock molded together with the housing and configured to cooperate with the lever in order to maintain it in the closed position, wherein the lock is connected to the housing with the help of two tabs, wherein each of the two tabs extend respectively from the lock as far as the housing in a direction perpendicular to the direction of coupling, and wherein each of the two tabs maintain the lock in an at-rest position in which a distance is provided between the lock and the housing.

2. The connector according to claim 1, wherein the housing forms an abutment limiting deformation of the two tabs when the lock is pressed in an actuating direction.

3. The connector according to claim 1, wherein the two tabs are disposed symmetrically to either side of the lock.

4. The connector according to claim 1, wherein the lock comprises two chamfers, a first external chamfer on which the lever slides when the lever is displaced towards the closed position, and a second internal chamfer on which the lever slides when the lever is displaced towards an opened position in order to be unlocked.

5. The connector according to claim 4, wherein the lever comprises two chamfers, each cooperating respectively with the first external chamfer and the second internal external chamfer of the lock when the lever is displaced from the closed position towards an opened position and conversely.

6. The connector according to claim 1, wherein the lever comprises two lever arms articulated on the housing about the axis of rotation of the lever and connected to one another via a handle, wherein the lock is present in a space situated to sides of the two lever arms in relation to the handle when the lever is in the closed position.

7. The connector according to claim 6, wherein the lock and the handle each have an actuating surface extending essentially in the same plane when the lever is in the closed position.

8. The connector according to claim 6, wherein the actuating surfaces of the lock and of the handle extend essentially in the same plane as a face of the housing.

9. The connector according to claim 4, wherein the lever pivots from the opened position towards the closed position as it moves away from one face of the housing in which the connector is coupled to the counter-connector.

10. A connection assembly, comprising:
the connector according to claim 1; and
the counter-connector, into which the connector and the counter-connector are displaced one towards the other in the course of rotation of the lever from the open position towards the closed position.
